(19) United States
(12) Patent Application Publication
(10) Pub. No.: US 2025/0307967 A1
(43) Pub. Date: Oct. 2, 2025

(54) Anonemis Research Software Hard Drive Protocol Policy Processes 24061

(71) Applicant: Renee Simenona Martinez, Beverly Hills, CA (US)

(72) Inventor: Renee Simenona Martinez, Beverly Hills, CA (US)

(21) Appl. No.: 18/624,117

(22) Filed: Apr. 2, 2024

(51) Int. Cl. G06Q 50/26; G06N 10/60

(52) U.S. Cl. CPC G06Q 50/265; G06N 10/60

(57) ABSTRACT

A thermodynamic process and system for material modification including software procedures and methodologies comprising specialized thermodynamics processes. The system applies thermal bonding and division through thermal contrasting in nuclear technology, medicine, computing, and military operations. The process uses heat to bond fibers while employing contrasting temperatures to maintain different thermal zones in confined areas for specific results. The system emphasizes absolute containment to prevent contamination and organizes disordered cells, atoms, and mechanisms. Both automated algorithms and operator technicians provide oversight to verify data within the system database using current and real-time information.

Neurological Profiles For Market Matching And Stimulus Presentation/Ser. No. 16/561,980
Pattern-based Classification/Ser. No. 16/912,009
Unusual Score Generators For A Neuro-linguistic Behavioral Recognition System/Ser. No. 17/164,210
SYSTEM AND METHOD FOR GENERATING CURATED INTERVENTIONS IN RESPONSE TO PATIENT BEHAVIOR/Ser. No. 17/213,164
Generating Ratings Predictions Using Neuro-response Data/Ser. No. 16/152,980
System, Method, And Computer Program Product For Analog And Mix-signal Circuit Placement/Ser. No. 16/238,274
USER BEHAVORIAL ANALYTICS FOR SECURITY ANOMALY DETECTION IN INDUSTRIAL CONTROL SYSTEMS/Ser. No. 17/442,834
Span Pointer Networks For Non-autoregressive Task-oriented Semantic Parsing For Assistant Systems 17/525,510
Personalized Content Delivery Using Neuro-response Priming Data/Ser. No. 16/193,930
ENHANCED RISK ASSESSMENT/Ser. No. 17/039,009
Training A Machine Learning System For ADC Compensation/Ser. No. 16/933,617
Efficient Memory Leak Detection In Database Systems/Ser. No. 18/169,271
Sharing Probabilities For User Traits/1532192
Compositions And Methods For Detecting Predisposition To Cardiovascular Disease/Ser. No. 17/857,723
Medical Image Analysis Method, Medical Image Analysis Device, And Medical Image Analysis System/17515466
Methods For Diagnosing An Autistic Spectrum Disorder/Ser. No. 16/967,361
Health And Wellness Management Technology/Ser. No. 16/891,403
Sensor Device And Methods/Ser. No. 16/471,552
Systems, Methods And Apparatuses Of Digital Assistants In An Augmented Reality Environment And Local Determination Of Virtual Object Placement And Apparatuses Of Single Or Multi-directional Lens As Portals Between A Physical World And A Digital World Component Of The Augmented Reality Environment/Ser. No. 16/853,815
NEUROLOGICAL REHABILITATION AND TRAINING METHOD UTILIZING OCULOMOTOR, VISUAL AND/OR VESTIBULAR REHABILITATION TASKS ON SUBJECTS WITH PHARMACOLOGICALLY INDUCED NEUROPLASTICITY/Ser. No. 17/316,077
Interactive And Analytical System That Provides A Dynamic Tool For Therapies To Prevent And Cure Dementia-related Diseases/Ser. No. 17/676,562
Molecule Counting Of Methylated Cell-free DNA For Treatment Monitoring/Ser. No. 18/187,578
Management Of Connected Sensor Devices/Ser. No. 17/390,811
Machine Learning Model To Determine A Proper Subset Of A Multimedia File For A Viewer Based On Their Interest/Ser. No. 17/521,668
Rule Creation For Code Analysis/Ser. No. 17/850,583
Methods, Systems, And Computer Readable Media For Suppressing Cookie Based Advertisement Retargeting/Ser. No. 15/374,653
Technique For Alignment Of A Mobile Device Orientation Sensor With The Earth's Coordinate System/Ser. No. 16/298,410
Mapping Non-attached Subnetworks/Ser. No. 16/692,034
Batch Normalization For Replicated Layers Of Neural Network/Ser. No. 16/923,006
Error And Manipulation Resistant Search Technology/Ser. No. 16/886,986
Batch Normalization For Replicated Layers Of Neural Network/Ser. No. 16/923,006

STATEMENT REGARDING FEDERALLY SPONSORED RESEARCH OR DEVELOPMENT Not Applicable

### NAMES OF PARTIES TO A JOINT RESEARCH AGREEMENT

The present invention was developed under a joint research agreement between Renee Simenona Martinez, Anonemis Research, and Scigenity Technology.

### INCORPORATION BY REFERENCE

Standard Application Requirements.

### STATEMENT REGARDING PRIOR DISCLOSURES BY THE INVENTOR OR A JOINT INVENTOR

Invention has not been disclosed.

### FIELD OF THE INVENTION

The present invention relates to the embodiment of a software application and methodology procedure with a critical outcome process, as it relates to AR thermodynamic, quantum science, and various tactical areas. This software application includes a user-interface with a customized operating system which yields to areas of telecommunications, automotives, transistors, data analysis, behavioral science and quantum approximation.

### BACKGROUND OF THE INVENTION

AR Thermodynamics Systems is an embodiment comprising of an algorithmic software process and system database that data source references are critically verified information regarding systems operations, atmospheric data and environmental intelligence, and sustainment resources. This system database uses current and real-time information which is vetted within the system queue for verification by both automated algorithms and operator oversight.

### SUMMARY OF THE INVENTION

The present application relates to the embodiment compromising of a software application process and methodology procedure systems with critical outcome processes, as it relates to a specialized thermodynamics process. Thermal bonding and division through Thermal Contrasting can be utilized across diverse fields including nuclear science, medicine, computing, and military operations. The process involves using heat to bond fibers while simultaneously employing contrasting temperatures, whether cold or neutral, maintaining various temperatures in confined areas to achieve specific outcomes with absolute containment. This software includes a user interface with a customized operating system which yields to areas of Thermodynamics both organized and disorganized, telecommunications, automotives, transliteration development, chips technology, communications, data analysis, behavioral science, medicine, behavioral science, nuclear science, space technology, defense, and quantum approximation.

### BRIEF DESCRIPTION OF THE DRAWINGS

Not Applicable

### DETAILED DESCRIPTION OF THE INVENTION

Software process with a critical interface embodiment which includes an algorithm which automatedly verifies content, environmental atmosphere, pre-programed requests by cross-referencing and produces real-time automated adjustments according to the real-time data observed around and programed regarding AR Thermodynamics, both organized and disorganized.

This process is essential elements to tactical, survival, and sustainment of other live or research on planets, recycling, obtaining observational data and lifestyle benefits.

This process procedures within various sectors stated in present application of which requires the AR Thermodynamics System Apparatus.

In one embodiment the software's operating system is developed with an interactive interface which analyzes content within cases studies and specialized database which consists of academic research observational, pre-programed, and environmental sensory data.

This database, in addition to pre-programmed requests, environmental data which allows the algorithm to optimize its operation in a specialized sequence which differs from the traditional or current popularized databases. The use of AR rapid data shuffling is key. Software process with a critical interface embodiment which includes an algorithm which automatedly verifies content, environmental atmosphere, pre-programed requests by cross-referencing and produces real-time automated adjustments according to the real-time data observed around and programed regarding AR Thermodynamics, both organized and disorganized. Thermal bonding and division through Thermal Contrasting can be utilized across diverse fields including nuclear science, medicine, computing, and military operations. The process involves using heat to bond fibers while simultaneously employing contrasting temperatures, whether cold or neutral, maintaining various temperatures in confined areas to achieve specific outcomes with absolute containment.

In another embodiment, sorting data by patterned repetition in the level of relevance for desired outcome is critical.

The invention can be implemented in various sectors including:
Telecommunications
Automotives
Transliteration development
Chip technology
Communications
Data analysis
Behavioral science
Transportation
Medicine
Nuclear science
Space technology
Defense
Quantum approximation
Organized/disorganized thermodynamics processes
Sustainability
Prolonging life
Pharmaceuticals
Environmental operations
Lifestyle assistance

What is claimed is:

1. A thermodynamic process control system comprising: a processor; a memory storing instructions that, when executed by the processor, cause the system to: implement a specialized thermodynamics process for converting between organized and unorganized forms of matter; perform thermal bonding and division operations using thermal contrasting; maintain different temperatures within defined containment areas; control material modification through calculated transference; perform data pattern analysis using AR rapid data shuffling; and sort data by pattern repetition based on relevance to desired outcomes.

2. The system of claim 1, further comprising: a cooling subsystem configured to implement thermal control in material science applications, wherein the cooling subsystem is adapted for use in chip technology and transistor development.

3. The system of claim 1, further comprising: a biomolecular thermodynamics subsystem configured to: analyze disease mechanisms; monitor cell migration; track cell division processes; and study cellular reactions to heat transference in dual ecosystems.

4. The system of claim 1, further comprising: dual cylinders configured for medical device applications, wherein the dual cylinders are structured to reduce contamination risks through thermal isolation between transference operations.

5. The system of claim 1, wherein the processor is further configured to: monitor environmental changes in terrestrial and extraterrestrial environments; and analyze thermal conditions in multiple planetary environments.

6. The system of claim 1, wherein the processor is further configured to: control nuclear reaction processes; maintain thermal precision in nuclear material handling; and regulate thermal conditions for aerospace and military applications.
